(19) United States
(12) Patent Application Publication
(10) Pub. No.: US 2015/0273595 A1
(43) Pub. Date: Oct. 1, 2015

(54) Device for Automatically Drilling Wheel Rim Online

(71) Applicants: Bowen XUE, Qinhuangdao (CN); Jiandong GUO, Qinhuangdao (CN); Weidong LIU, Qinhuangdao (CN); Changjiu REN, Qinhuangdao (CN); Yongning WANG, Qinhuangdao (CN); Zhihua ZHU, Qinhuangdao (CN); Changhai LI, Qinhuangdao (CN)

(72) Inventors: Bowen XUE, Qinhuangdao (CN); Jiandong GUO, Qinhuangdao (CN); Weidong LIU, Qinhuangdao (CN); Changjiu REN, Qinhuangdao (CN); Yongning WANG, Qinhuangdao (CN); Zhihua ZHU, Qinhuangdao (CN); Changhai LI, Qinhuangdao (CN)

(73) Assignee: CITIC DICASTAL CO., LTD, Qinhuangdao (CN)

(21) Appl. No.: 14/664,136

(22) Filed: Mar. 20, 2015

(30) Foreign Application Priority Data
Mar. 25, 2014 (CN) 201410111455.0

(51) Int. Cl. B23B 47/28; B23B 41/00

(52) U.S. Cl. CPC B23B 47/281; B23B 41/00; B23B 2215/08; B23B 2222/04

(57) ABSTRACT

The present invention provides an automatic wheel rim online drilling device, comprising a frame, an air cylinder, a profiling drill jig, a drill bush, a servo electric cylinder, a drilling power head, etc. Firstly, a sensor enables a wheel to be positioned, and the air cylinder causes left clamping blocks to move rightward by two guide rods and guide sleeves so as to clamp the wheel jointly with a right clamping block; the servo electric cylinder causes a drilling system to move toward the wheel and the profiling drill jig can first come into good contact with the wheel rim and then the servo electric cylinder moves continuously to compress upper and lower springs so that the drill bit enters the drill bush, and at this time the drilling power head drives the drill bit to rotate, thus starting drilling on the wheel rim. By using the device of the present invention, X-ray rejects of wheels can be automatically marked by drilling, and the device can adapt to flow casting spun blanks with thick rims; and through orientation of the drill bush, the situation that the drill bit is frequently broken when drilling on the arc surface of the outer side of the wheel rim can be effectively avoided.

### TECHNICAL FIELD

The present invention relates to a drilling device, in particular to a drilling device for a circumferential object surface.

### BACKGROUND ART

During manufacturing of aluminum alloy wheels, to avoid potential safety risk due to loss of X-ray rejects, traditionally X-ray rejected products are drilled in the wheel rims so as to be accurately determined as rejects in subsequent airtight testing. In a traditional method of drilling, the wheels are drilled one by one by a worker with an electric hand drill, with high labor intensity and low efficiency; although automatic drilling devices are also designed by many enterprises, a drill bit cannot be positioned at all due to an arc surface of the outer side of the wheel rim during drilling, and therefore the drill bit is frequently broken. By adopting the device in the present invention, the above problems can be totally avoided while the production efficiency is improved, and the device can adapt to workpieces with thick wheel rims, such as flow casting spun blanks, and has a wider application range.

### BRIEF DESCRIPTION

The object of the present invention is to provide an automatic wheel rim drilling device, by means of which online automatic drilling of a wheel rim can be achieved, and the service life of a drill bit can be effectively prolonged.

To achieve the above object, the present invention adopts the following technical solution: an automatic wheel rim online drilling device comprises a frame, guide rods, guide sleeves, left clamping blocks, a lower supporting plate, an air cylinder, a right clamping block, a profiling drill jig, a drill bush, a bracket, a servo electric cylinder, a guide rail, a support platform, an upper spring, an upper guide post, an upper sliding sleeve, an upper pressing plate, a drilling power head, a lower spring, a lower guide post, a lower sliding sleeve, a lower pressing plate and a drill bit. The two guide rods are fixed under the frame, and the two guide sleeves cooperating with the guide rods are mounted below the two left clamping blocks; the air cylinder is fixed above the lower supporting plate, and an output rod of the air cylinder is connected with a middle connecting part between the two left clamping blocks; and the right clamping block is fixed on one side of a roller table.

The drill bush is mounted in the middle of the profiling drill jig, the two ends of which are hinged to one end of each of the upper guide post and the lower guide post respectively; the upper sliding sleeve cooperates with the upper guide post, and is fixed on the right side of the bracket; the upper pressing plate mounted at one end of the upper guide post can keep the upper spring sleeved around the outer side of the upper guide post in a compressed state; the lower sliding sleeve cooperates with the lower guide post, and is also fixed on the right side of the bracket; the lower pressing plate mounted at one end of the lower guide post can keep the lower spring sleeved at the outer side of the lower guide post in a compressed state; the drilling power head, at an output end of which is mounted the drill bit, is fixed on the right side of the bracket, thus forming a drilling system of the device.

The lower part of the bracket is connected with the support platform fixed on the right side of the frame by the guide rail; and the servo electric cylinder is mounted on the right side of the support platform, and an output end thereof is connected with the bracket, therefore achieving feed movement of the drilling system.

In practice, firstly a sensor enables a wheel to be positioned, and the air cylinder causes the left clamping blocks to move rightward by the two guide rods and the guide sleeves so as to clamp the wheel jointly with right clamping block; the servo electric cylinder causes the drilling system to move toward the wheel, so that the profiling drill jig can firstly come into good contact with the wheel rim, and then the servo electric cylinder moves continuously to compress the upper and lower springs so that the drill bit enters the drill bush, and at this time the drilling power head drives the drill bit to rotate, thus starting drilling on the wheel rim.

By using the device of the present invention, X-ray rejects of wheels can be automatically marked by drilling, and the device can adapt to flow casting spun blanks with thick rims; through orientation of the drill bush, the situation that the drill bit is frequently broken when drilling on the arc surface of the outer side of the wheel rim can be effectively avoided; and meanwhile, the device has the characteristics of high degree of automation, advanced process, safe and stable performance, wide application range, etc.

### DESCRIPTION OF DRAWINGS

FIG. 1 is a front view of an automatic wheel rim online drilling device of the present invention.

FIG. 2 is a top view of an automatic wheel rim online drilling device of the present invention.

FIG. 3 is a top view of an automatic wheel rim online drilling device of the present invention in operation.

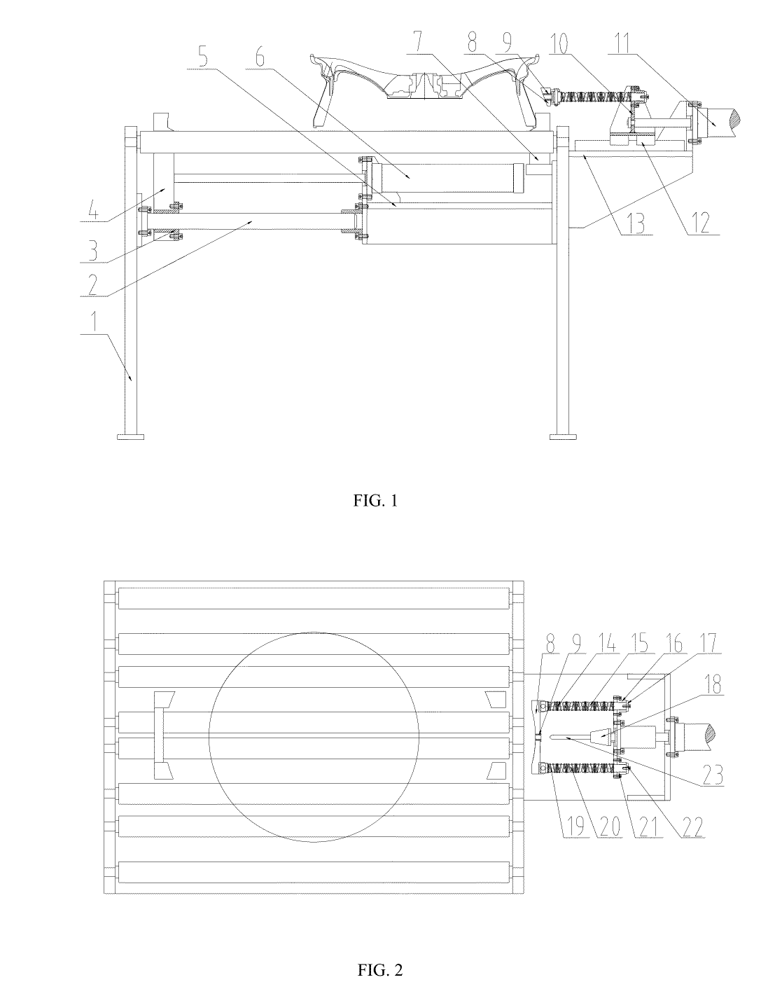

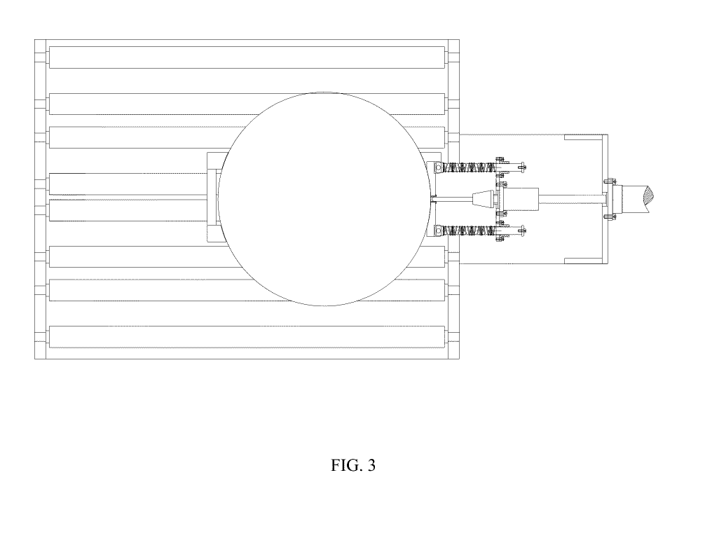

In the figures, 1—frame, 2—guide rod, 3—guide sleeve, 4—left clamping block, 5—lower supporting plate, 6—air cylinder, 7—right clamping block, 8—profiling drill jig, 9—drill bush, 10—bracket, 11—servo electric cylinder, 12—guide rail, 13—support platform, 14—upper spring, 15—upper guide post, 16—upper sliding sleeve, 17—upper pressing plate, 18—drilling power head, 19—lower spring, 20—lower guide post, 21—lower sliding sleeve, 22—lower pressing plate, 23—drill bit.

### DETAILED DESCRIPTION

Details and operation of the specific device provided by the invention will be described below in conjunction with the accompanying drawings.

The device comprises a frame 1, guide rods 2, guide sleeves 3, left clamping blocks 4, a lower supporting plate 5, an air cylinder 6, a right clamping block 7, a profiling drill jig 8, a drill bush 9, a bracket 10, a servo electric cylinder 11, a guide rail 12, a support platform 13, an upper spring 14, an upper guide post 15, an upper sliding sleeve 16, an upper pressing plate 17, a drilling power head 18, a lower spring 19, a lower guide post 20, a lower sliding sleeve 21, a lower pressing plate 22 and a drill bit 23. The two guide rods 2 are fixed under the frame 1, and the two guide sleeves 3 cooperating with the guide rods 2 are mounted below the two left clamping blocks 4; the air cylinder 6 is fixed above the lower supporting plate 5, and an output rod of the air cylinder 6 is connected with a middle connecting part between the two left clamping blocks 4; and the right clamping block 7 is fixed to one side of a roller table.

The drill bush 9 is mounted in the middle of the profiling drill jig 8, the two ends of which are hinged to one end of each of the upper guide post 15 and the lower guide post 20 respectively; the upper sliding sleeve 16 cooperates with the upper guide post 15, and is fixed on the right side of the bracket 10; the upper pressing plate 17 mounted at one end of the upper guide post 15 can keep the upper spring 14 sleeved around the outer side of the upper guide post 15 in a compressed state; the lower sliding sleeve 21 cooperates with the lower guide post 20, and is also fixed on the right side of the bracket 10; the lower pressing plate 22 mounted at one end of the lower guide post 20 can keep the lower spring 19 sleeved around the outer side of the lower guide post 20 in a compressed state; the drilling power head 18, at an output end of which is mounted the drill bit 23, is fixed on the right side of the bracket 10, thus forming a drilling system of the device.

The lower part of the bracket 10 is connected with the support platform 13 fixed on the right side of the frame 1 by the guide rail 12; and the servo electric cylinder 11 is mounted on the right side of the support platform 13, and an output end thereof is connected with the bracket 10, therefore achieving feed movement of the drilling system.

During operation, firstly a sensor enables a wheel to be positioned, and the air cylinder 6 causes the left clamping blocks 4 to move rightward by using the two guide rods 2 and the guide sleeves 3 so as to clamp the wheel jointly with the right clamping block 7; the servo electric cylinder 11 causes the drilling system to move toward the wheel so that the profiling drill jig 8 can first come into good contact with the wheel rim, and then the servo electric cylinder 11 moves continuously to compress the upper and lower springs so that the drill bit 23 enters the drill bush 9, and at this time the drilling power head drives the drill bit 23 to rotate, thus starting drilling on the wheel rim.

1. An automatic wheel rim online drilling device, comprising a frame (1), guide rods (2), guide sleeves (3), left clamping blocks (4), a lower supporting plate (5), an air cylinder (6), a right clamping block (7), a profiling drill jig (8), a drill bush (9), a bracket (10), a servo electric cylinder (11), a guide rail (12), a support platform (13), an upper spring (14), an upper guide post (15), an upper sliding sleeve (16), an upper pressing plate (17), a drilling power head (18), a lower spring (19), a lower guide post (20), a lower sliding sleeve (21), a lower pressing plate (22) and a drill bit (23), characterized in that the two guide rods (2) are fixed under the frame (1), and the two guide sleeves (3) cooperating with the guide rods (2) are mounted below the two left clamping blocks (4); the air cylinder (6) is fixed above the lower supporting plate (5), and an output rod of the air cylinder (6) is connected with a middle connecting part between the two left clamping blocks (4); the right clamping block (7) is fixed to one side of a roller table; the drill bush (9) is mounted in the middle of the profiling drill jig (8), the two ends of which are hinged to one end of each of the upper guide post (15) and the lower guide post (20) respectively; the upper sliding sleeve (16) cooperates with the upper guide post (15), and is fixed on the right side of the bracket (10); the upper pressing plate (17) mounted at one end of the upper guide post (15) keeps the upper spring (14) sleeved around the outer side of the upper guide post (15) in a compressed state; the lower sliding sleeve (21) cooperates with the lower guide post (20), and is also fixed on the right side of the bracket (10); the lower pressing plate (22) mounted at one end of the lower guide post (20) keeps the lower spring (19) sleeved around the outer side of the lower guide post (20) in a compressed state; the drilling power head (18), at an output end of which is mounted the drill bit (23), is fixed on the right side of the bracket (10), thus forming a drilling system of the device; the lower part of the bracket (10) is connected with the support platform (13) fixed on the right side of the frame (1) by the guide rail (12); and the servo electric cylinder (11) is mounted on the right side of the support platform (13), and an output end thereof is connected with the bracket (10).
